(19) United States
(12) Patent Application Publication
(10) Pub. No.: US 2007/0091349 A1
(43) Pub. Date: Apr. 26, 2007

(54) Image forming device

(76) Inventor: Sachiko Yoshimura, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,159

(22) Filed: Oct. 26, 2005

(51) Int. Cl. G06K 15/00

(52) U.S. Cl. 358/1.14; 358/1.15

(57) ABSTRACT

It is assumed that an image forming device has a function such that, while a specific resource is in a state of occupancy, users other than the user who gave instructions for occupancy start are prevented from using the resource. In such an image forming device, a storage unit stores a common password. Further, an occupancy unit, upon receiving user information identifying the user, executes resource occupancy. A cancellation unit, upon entry of received user information or common password, cancels occupancy. With such a configuration, even users other than the one who gave instructions for occupancy start can cancel the resource occupancy, provided they know the common password stored in the storage unit.

### FIELD OF THE INVENTION

The present invention relates to an image forming device such as a printer, photocopier, multifunction machine and the like, and more particularly to an image forming device having a function such that, while a specific resource is in a state of occupancy, users other than the user who gave instruction for occupancy start are prevented from using the resource.

### BACKGROUND INFORMATION

In recent years, image forming devices such as printers, photocopiers, multifunction machines and the like have become widely used. Because such image forming devices are often used by more than one user, there are problems with regard to the way in which such resources are shared.

For example, when printing is to be made using special sheets, the necessary number of sheets are loaded onto an image forming device feed tray, and with the image forming device in such a state, a print request is made by a higher-level device such as a PC. However, during the time from when the sheets have been set in this manner until time of print request, there are cases where other users make a print request, and because of this print request, the special sheets set in the feed tray are inadvertently used.

Thus, a conventional image forming device 100 as shown in FIG. 4 is configured so that an operating unit 101 is used to give instructions to commence occupancy of a resource (feed tray), and at the same time to enter an authentication password unknown to other users. With such a configuration, the control unit 110 causes the feed tray to be locked, and until the time when a preset occupancy time has passed or an authentication password is reentered, use of the feed tray is not allowed.

When another user wishes to use the resource in a state of occupancy, a reservation for resource occupancy can be set. In other words, once occupancy by the previous user is ended, resource occupancy transfers to the subsequent user.

As described above, in accordance with the prior art, once an image forming device is a state of occupancy, until a preset occupancy time has passed or an authentication password is entered, the resource cannot be used. For this reason, until the preset occupancy time has passed, other users who do not know the authentication password are not allowed to use the resource.

The present invention was proposed in light of the above conventional circumstances, and its object is to provide an image forming device that allows a user to cancel resource occupancy as necessary.

### SUMMARY OF THE INVENTION

The present invention employs the following means to achieve the above object.

Specifically, the present invention assumes an image forming device having a function such that, while a specific resource is in a state of occupancy, users other than the user who gave instruction for occupancy start are prevented from using the resource. In such an image forming device a storage unit stores a common password, and an occupancy unit executes occupancy upon receipt of user information identifying a user.

A cancellation unit cancels occupancy in response to entry of received user information or of the common password.

With such a configuration, even users other than the user who gave instructions for occupancy start, provided they know a common password stored in the storage unit, can cancel the resource occupancy. It is preferable that the password be known only to certain persons such as an administrator.

With the present invention, resource occupancy can be cancelled as necessary. More specifically, when there is urgent need to use a resource in a state of occupancy, the resource occupancy can be immediately cancelled without having to wait until expiration of the preset occupancy time. Further, because persons who can cancel the resource occupancy in this manner are limited to certain persons such as an administrator, the problem of users other than the administrator canceling the resource occupancy can be prevented.

### BRIEF DESCRIPTION OF THE DRAWINGS

FIG. 1 is a schematic functional block diagram of a multifunction machine employing the present invention;

FIGS. 2A-2B are diagrams showing operation screens in a display state;

FIG. 3 is a flowchart showing operations of a multifunction machine employing the present invention; and

FIG. 4 is a schematic functional block diagram of a conventional image forming device.

### DETAILED DESCRIPTION OF THE PREFERRED EMBODIMENTS

An embodiment of the present invention will be explained in detail with reference to the drawings.

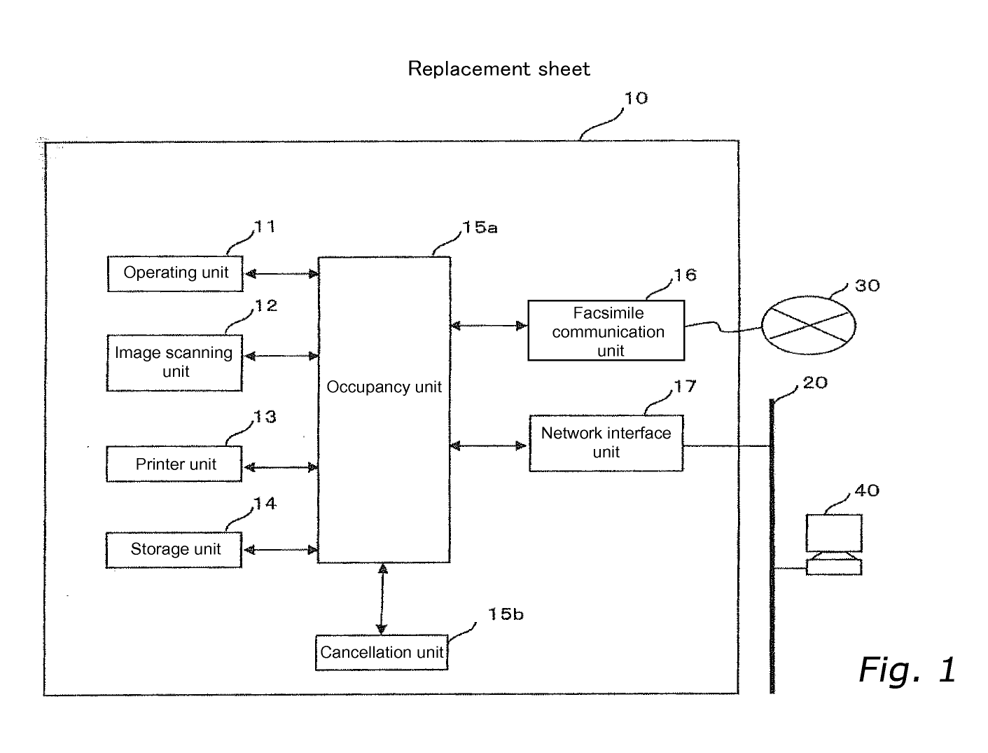

FIG. 1 is a schematic functional block diagram of a multifunction machine 10 employing the present invention. It is assumed that this multifunction machine 10 is connected to a public line 30, and to a PC 40 serving as a higher-level device via a LAN (Local Area Network) 20.

An operating unit (receiving unit) 11 is means for receiving instructions from a user. An image scanning unit 12 is means for scanning an original document to obtain image data. A printer unit 13 is means for printing the image data on a recording paper. A storage unit 14 is means for storing image data, common password, and other various setting information. An occupancy unit 15a is means for controlling resource occupancy, and a cancellation unit 15b is means for canceling resource occupancy. A facsimile communication unit 16 is means for carrying out communications via the public line 30. A network interface unit 17 is means for communicating with the PC 40 or the like via the LAN 20.

The constitution of the above multifunction machine 10 as well as the operations thereof will now be explained.

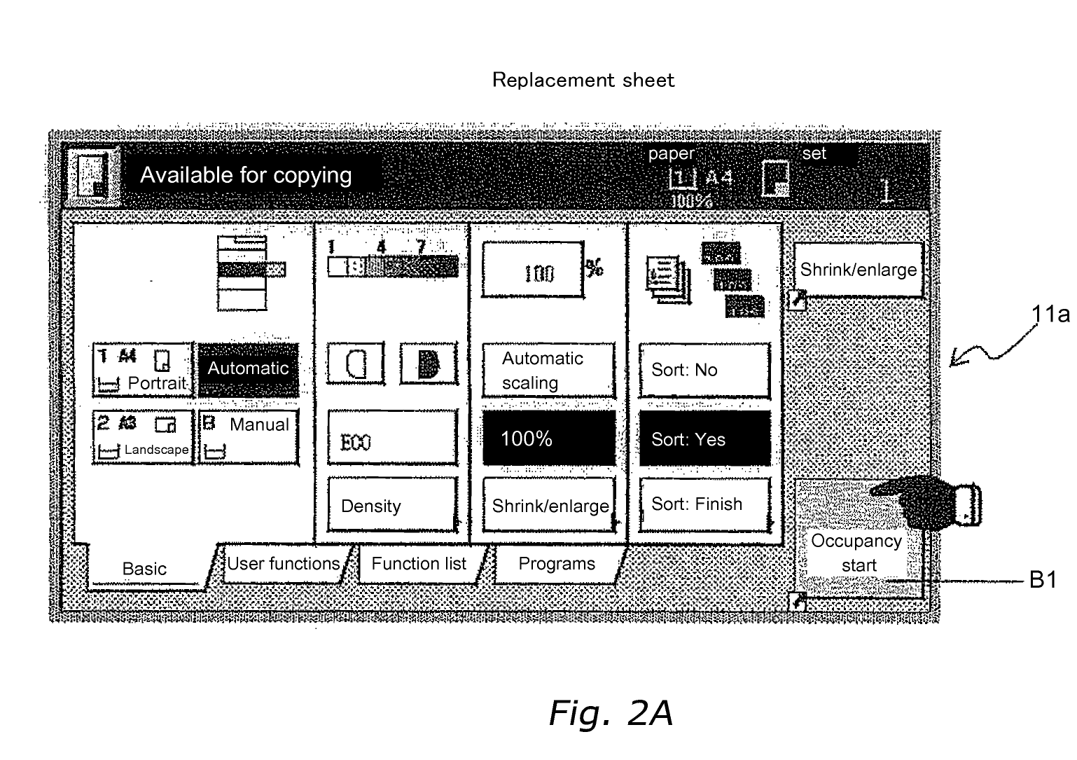

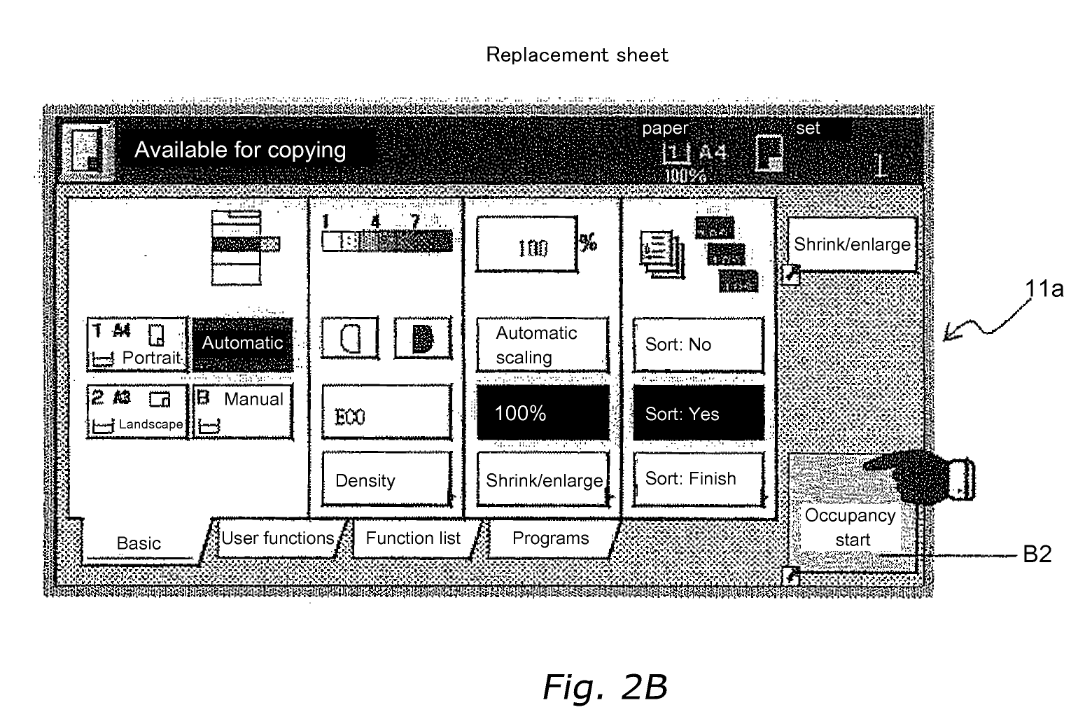

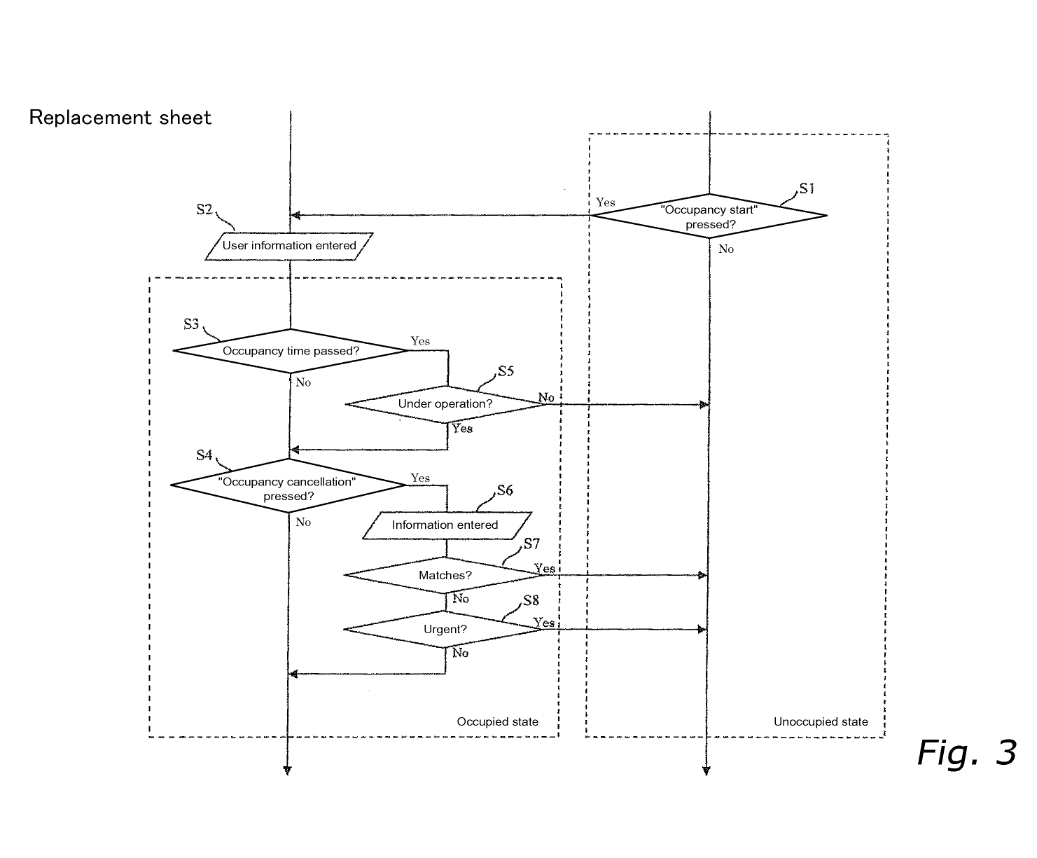

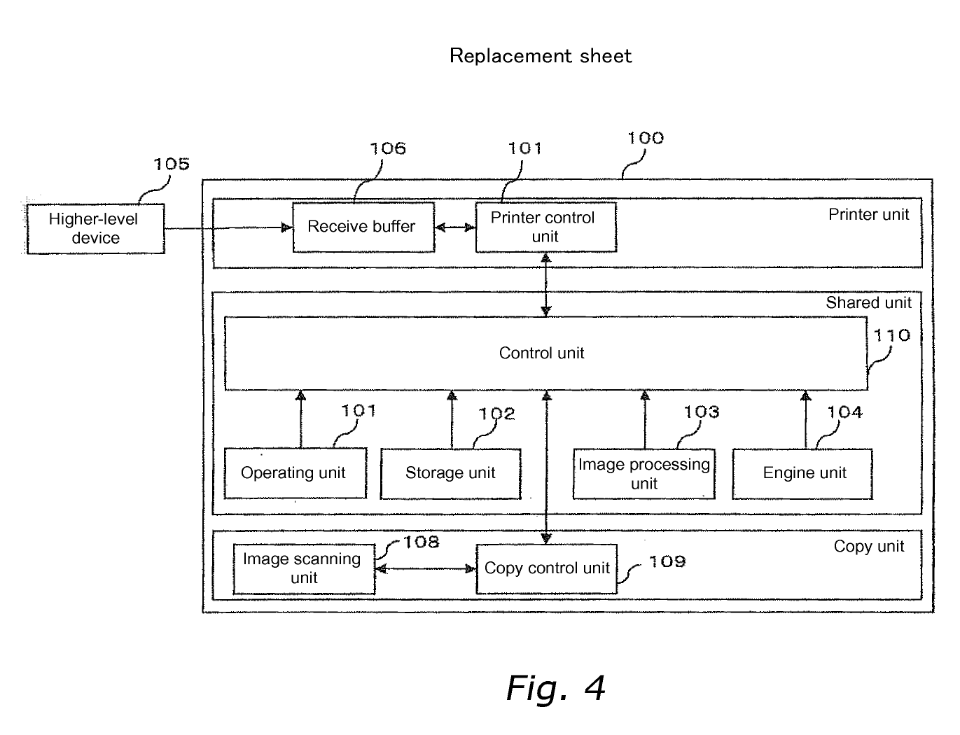

When a copy is to be made using a special type of sheet, first, instructions are made for feed tray occupancy start. More specifically, as shown in FIG. 2A, a setting screen 11a is displayed on the operating unit 11, and an occupancy start button B1 included in this setting screen 11a is pressed (FIG. 3, Step S1).

With this configuration, the operating unit 11 notifies the occupancy unit 15a that instructions have been made for feed tray occupancy start, and the occupancy unit 15a, having received this notice, causes a screen for prompting entry of user information to be displayed on the operating unit 11. User information is information identifying a user; more specifically, it is a password, user name and the like.

Next, when the user who gave instructions for occupancy start enters his or her own user information from the operating unit 11 (FIG. 3, Step 2), the occupancy unit 15a stores this user information, locks the feed tray, and starts counting occupancy time. As in the prior art, this occupancy time can be preset.

Once the feed tray is thus in a state of occupancy, basically, until the occupancy unit 15a measures passage of occupancy time and the cancellation unit 15b cancels occupancy, no other users are allowed to use the feed tray. Therefore, the user who gave instructions for occupancy start can perform a copy operation without worrying that the special sheets set in the feed tray might be used by other users.

There may be cases where a copy operation cannot be immediately started even though the feed tray is in a state of occupancy, and in such cases, it can be expected that occupancy time will pass without completion of the copy operation. Therefore, if a series of operations have not been completed even though occupancy time has passed, the occupancy state is maintained (FIG. 3, Step S3: Yes to S5: Yes).

There may be cases such that while the feed tray is in a state of occupancy, a user wishes to cancel occupancy. There are various reasons for canceling occupancy, including cases where the user him/herself who gave instructions for occupancy start wants to cancel the instruction, where other users would like to occupy the feed tray, or where there is urgent need to cancel the feed tray occupancy, and it would not be preferable to have occupancy cancelled in the same manner for all such cases. Thus, in the present invention, by employing the following method, when the user him/herself who gave instructions for occupancy start would like to cancel the instruction, or when there is urgent need to cancel feed tray occupancy, occupancy can be cancelled.

More specifically, when a user wishes to cancel feed tray occupancy, as shown in FIG. 2B, the setting screen 11a is displayed on the operating unit 11, and the occupancy cancel button B2 contained in this setting screen 11a is pressed (FIG. 3, Step S4). When the occupancy cancel button B2 is thus pressed, as described above, a screen prompting entry of user information is displayed on the operating unit 11, and the user who gave instructions for occupancy cancellation enters his or her user information from the operating unit 11 (FIG. 3, Step S6).

The cancellation unit 15b determines whether the user information entered when occupancy started and user information entered when occupancy was canceled match. If the information matches, it is deemed that the instructions were cancelled by the user him/herself who gave instructions for occupancy start, and feed tray occupancy is thus cancelled (FIG. 3, Step 7: Yes).

On the other hand, when the information does not match, the cancellation unit 15b reads the common password stored in storage means 14 to determine whether this password matches the user information entered when occupancy was cancelled. When the information matches, it is deemed that the feed tray occupancy urgently needs to be cancelled, and feed tray occupancy is thus cancelled (FIG. 3, Step 8: Yes).

The above password is known only to certain persons such as an administrator. With such a configuration, only certain persons can urgently cancel feed tray occupancy, and for other users, an occupancy function identical to that in a conventional device is provided.

As described above, with the present invention, resource occupancy can be cancelled as necessary. In other words, when there is urgent need to use a resource in a state of occupancy, resource occupancy can be immediately cancelled, without having to wait for elapse of occupancy. Moreover, because persons who can cancel resource occupancy in such a manner are limited to certain persons such as an administrator, the problem of resource occupancy being canceled by other users does not arise.

While in this embodiment user instructions are received by the operating unit 11 of the multifunction machine 10, the present invention places no particular limitations with respect thereto. Specifically, the same effects as set forth above can be achieved with a configuration in which user instructions are received by the PC 40 or the like connected to the multifunction machine 10.

Further, in this embodiment, explanation was made of a case where because copies are to be made using special sheets, the feed tray is occupied, but no particular limitations are placed on the resource to be occupied. In addition, the operations are not limited to copying, and may, for example, be printing.

Further, while no special reference was made in the above explanations, in cases where notwithstanding instructions for cancellation, occupancy is cancelled, as in the prior art, reservations for the subsequent occupancy can be set. Alternatively, it is also effective to have occupant information (user information entered at commencement of occupancy), remaining occupancy time information and the like displayed on a screen of the operating unit 11.

What is claimed is:

1. An image forming device having a function such that, while a specific resource is in a state of occupancy, users other than the user who gave instructions for occupancy start are prevented from using the resource, comprising:
a storage unit for storing a common password;
an occupancy unit for receiving user information identifying the user to execute occupancy of the specific resource; and
cancellation means for canceling occupancy in response to the entry of received user information or common password.

2. An image forming device according to claim 1, wherein cancellation means cancels the occupancy when the occupancy state has continued for a certain time.
